(19) United States
(12) Patent Application Publication
(10) Pub. No.: US 2007/0017627 A1
(43) Pub. Date: Jan. 25, 2007

(54) Apparatus for and process of manufacturing a multi-ply absorbent paper product and product thus obtained

(75) Inventor: Riccardo Michelotti, Prescia, Pistoia (IT)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS, GOTEBORG (SE)

(21) Appl. No.: 11/527,423

(22) Filed: Sep. 27, 2006

Related U.S. Application Data
(63) Continuation of application No. PCT/EP05/03451, filed on Apr. 1, 2005.

(30) Foreign Application Priority Data
Apr. 2, 2004 (IT) MI2004A000675

(51) Int. Cl. B31F 1/00

(52) U.S. Cl. 156/205; 156/210; 156/462

(57) ABSTRACT

Apparatus for producing a multi-ply, absorbent paper product includes a first embossing unit, having a first and a second embossing roller that are coupled and suitable for embossing and associating together at least one first ply of paper and at least one second ply of paper, and at least one second embossing unit separate from the first embossing unit, having at least one third embossing roller coupled with a fourth roller and suitable for embossing at least one third ply of paper and associating it externally with the first or second ply of paper.

### FILED OF THE INVENTION

The present invention relates to an apparatus for and process of manufacturing a multi-ply absorbent paper product and to the product thus obtained.

### BACKGROUND OF THE INVENTION

Conventional systems for producing a multi-ply absorbent paper product generally have an embossing unit comprising a plurality of embossing rollers coupled with each other.

The rotation of the embossing rollers can be synchronized to have a greater or lesser tolerance according to the relationship that is intended to be established between the positions of the projections of the plies that are associated, i.e. joined together.

Such systems can have drawbacks linked to the need to synchronize and maintain the embossing rollers perfectly synchronized in order to obtain the desired result.

Due to the fine adjustment necessary for their correct operation, such systems can also have limits in productivity and in their versatility to be adapted to different types of product.

The end product also sometimes suffers from unsuitable properties of softness, volume, tactile effect and absorbency due both to the presence of gluing points common to more than two plies and to an unsuitable choice in the relationship with which the various plies are associated which determines a low percentage of free inner volume.

To improve the absorbency and volume of the product, the base ply is obtained through a process in which the drying is effected with a through-flow of hot air (known as a “Through Air Dried product”) that achieves the desired result but at the expense of considerable energy consumption and, consequently, considerable cost.

### OBJECTS OF THE INVENTION

The technical problem to be solved by the present invention is, therefore, that of realizing an apparatus for and process of manufacturing a multi-ply absorbent paper product and a product thus obtained that allow the aforementioned technical drawbacks of the prior art to be eliminated.

An additional problem to be solved by the invention is that of realizing an apparatus for manufacturing a multi-ply absorbent paper product that is extremely flexible and which apparatus is highly efficient and productive.

Another problem to be solved by the invention is that of realizing a simple and cost-effective process of manufacturing a high quality multi-ply absorbent paper product.

A further problem to be solved by the present invention is that of providing a multi-ply absorbent paper product having high qualities of absorbency, softness, tactile effect and volume.

### SUMMARY OF THE INVENTION

The technical problem upon which the present invention is based are solved by an apparatus, process and product as defined in the claims, respectively. An apparatus for producing a multi-ply absorbent paper product, comprising a first embossing unit, having a first and a second embossing roller that are coupled and arranged such as to emboss and associate together at least a first ply of paper and at least one second ply of paper, and at least one second embossing unit, separate from said first embossing unit and having at least one third embossing roller coupled with a fourth roller and arranged so as to emboss at least one third ply of paper and associate it externally with said at least one first or second ply of paper.

The invention also discloses a process of manufacturing a multi-ply absorbent paper product, comprising the steps of embossing at least one first ply of paper and at least one second ply of paper by their association being carried out in a first embossing unit, and then embossing at least one third ply of paper by the association of said third ply of embossed paper externally with said first or second ply being carried out in at least one second embossing unit separate from the first embossing unit, and establishing a random or predetermined relationship between the position of the projections of said third ply and that of the projections of said first and second ply realized in said first embossing unit.

Finally, the invention provides a multi-ply absorbent paper product, comprising at least one first ply of paper and at least one second ply of paper associated through projections of equal pitch and height positioned in a point-to-point relationship, and at least one outer third ply of paper associated with said first or second ply through projections positioned in a random or established relationship with said projections in a point-to-point relationship of the combination of said first and second ply.

Additional advantageous characteristics of the present invention are defined in the dependent claims.

### BRIEF DESCRIPTION OF THE DRAWINGS

Further characteristics and advantages of the invention shall become clearer from the description of a preferred but not exclusive embodiment of the system for producing a multi-ply absorbent paper product according to the finding, illustrated for indicating and not limiting purposes in the attached drawings, in which:

FIG. 1 schematically shows an apparatus for producing a web of three-ply paper in which the first and the second ply are associated in the first embossing unit with the projections in a point-to-point relationship, whereas the third ply is associated with one of the previous plies in a second embossing unit with the projections arranged in a random relationship with respect to the projections created in the first embossing unit on the first and second ply;

FIG. 2 schematically shows an apparatus for producing a web of three-ply paper in which the first and the second ply are associated in the first embossing unit with the projections in a point-to-point relationship, whereas the third ply is associated with one of the previous plies in a second embossing unit with the projections arranged staggered with respect to the projections created in the first embossing unit on the first and second ply;

FIG. 3 shows the apparatus of FIG. 2 in which the third embossing roller of the second embossing unit operates the simultaneous embossing of two plies;

FIG. 4 schematically shows an optional intermediate processing unit between the first and the second embossing units suitable for applying one or more non-embossed plies to the first and/or second embossed ply coming out from the first embossing unit.

### DETAILED DESCRIPTION OF THE INVENTION

With reference to these Figures, an apparatus for producing a multi-ply absorbent paper product is shown, wholly indicated with reference numeral 1.

The apparatus 1 comprises a first embossing unit 2 suitable for embossing and associating together at least one first ply 3 and at least one second ply 4, and at least one second embossing unit 5 separate from the first embossing unit 2 and suitable for embossing at least one third ply 6 and associating it with the first or second ply 3 or 4.

From that which has been said up to now it is clear that the apparatus is capable of realizing a product having a minimum number of three plies but that any number of additional plies could be considered that can be applied at the first and/or subsequent embossing units.

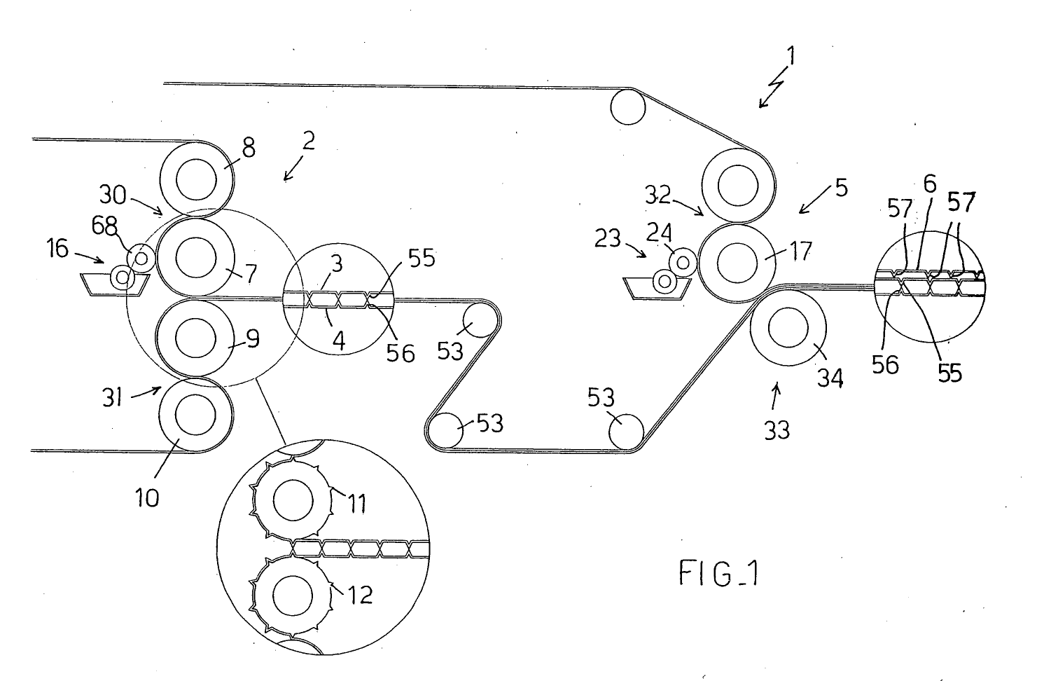

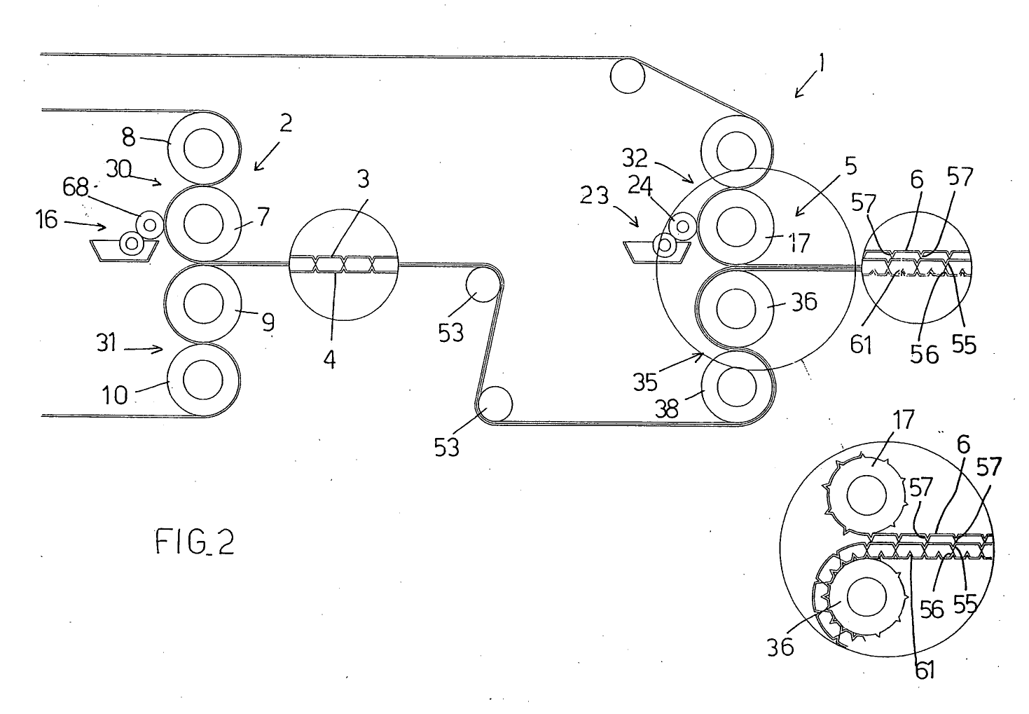

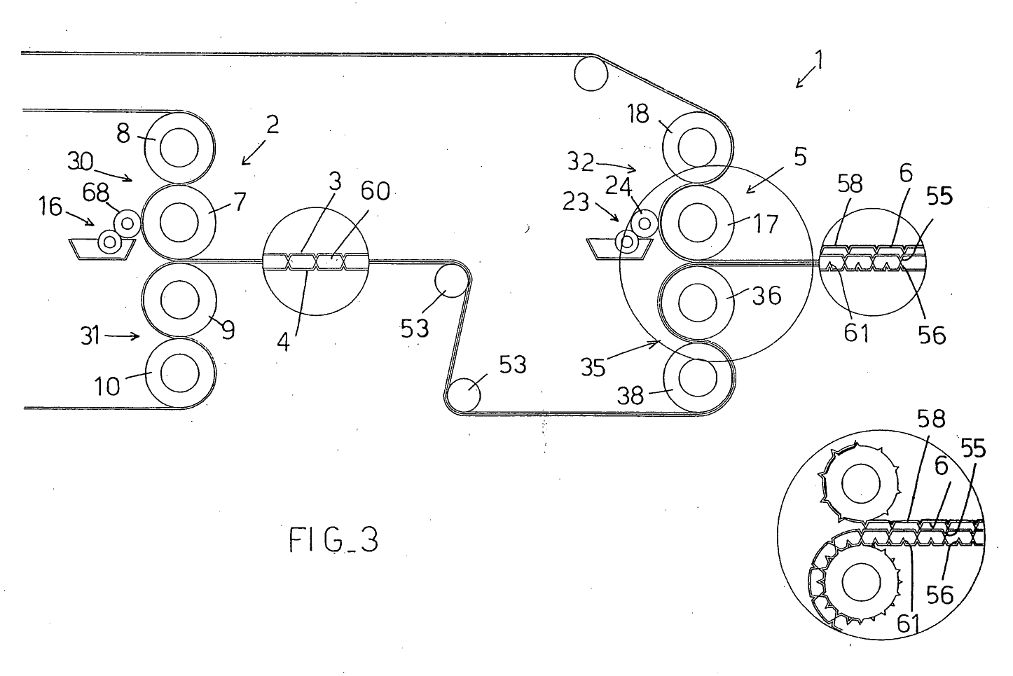

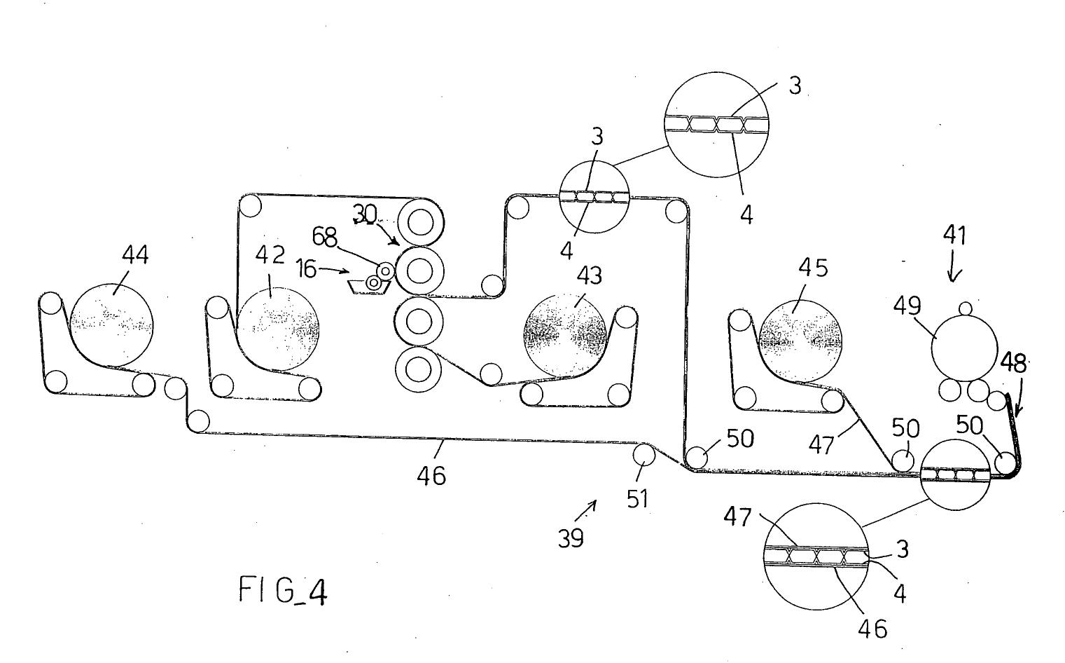

Thus, in FIGS. 1 and 2, the product has three plies, in FIG. 3 the product has four plies, two of which are applied in the second embossing unit, and in FIG. 4 the semi-worked product has four plies to which at least one ply is added at the subsequent embossing unit to realize the end product.

On the other hand, although just two embossing units 2 and 5 are illustrated in the drawings, it is conceivable to foresee an apparatus having any number of separate modular embossing units.

In the case illustrated, the first embossing unit 2 has a first sub-unit 30 made up of a first roller 7, preferably made from steel, coupled with a first elastic roller 8, preferably made from rubber, and a second sub-unit 31 identical to the first sub-unit 30 and made up of a second roller 9, preferably made from steel, coupled with a second elastic roller 10, preferably made from rubber.

The first and the second embossing rollers 7 and 9 have, on their side surface, projections 11 and 12 suitable for reproducing corresponding projections on the plies on which they are imprinted.

The first and second embossing roller 7 and 9 are also coupled tangentially so as to define a passage through which the plies to be associated are pressed against each other.

The projections 11 and 12 of the rollers 7 and 9 in the embodiment of FIG. 1 not only have the same pitch and height, but in use are also matching to associate with the projections created on the plies that cross the rollers 7 and 9 with a point-to-point relationship.

Coupled with the first sub-unit 30 of the first embossing unit 2, there is a gluing unit 16 comprising a first gluing roller 68 coupled with the first embossing roller 7 and suitable for applying an adhesive layer onto the tips of the projections of the ply (or of the most outer ply in the case of many plies) taken from the first embossing roller 7 before association with the ply (or with the most outer ply in the case of many plies) taken from the second embossing roller 9.

The second embossing unit 5 has a first sub-unit 32, identical to the first sub-unit 30 of the first embossing unit 2, made up of a third embossing roller 17, preferably made from steel, having projections suitable for producing corresponding projections on the ply (or on the plies) on which they are imprinted, and coupled with a third elastic roller 18, preferably made from rubber.

The sub-unit 32 also has a gluing unit 23 associated with it and comprising a second gluing roller 24 coupled with the third embossing roller 17.

In FIG. 1, the second embossing unit 5 also has a second sub-unit 33 consisting of a fourth roller 34 without projections coupled tangentially with the embossing roller 1, whereas in FIGS. 2 and 3 it comprises a second sub-unit 35 identical to the first sub-unit 30 of the first embossing unit 2, made up of a fourth embossing roller 36 with projections, preferably made from steel, coupled with a fourth elastic roller 38, preferably made from rubber. The fourth embossing roller 36 is coupled tangentially with the third embossing roller 17 to associate the plies that cross them.

For the passage of the combination of plies obtained from the first embossing unit 2 to the second embossing unit 5, suitable relay and guiding rollers 53 are provided.

In FIG. 4, the apparatus comprises an applying unit of at least one ply of non-embossed paper outside of the combination of plies obtained from the first embossing unit 2, and a reeling unit 41 of the semi-worked product 48 thus obtained, used subsequently to supply the semi-worked product 48 to the second embossing unit 5.

In particular, in FIG. 4, as well as the supply reels 42 and 43 of the plies 3 and 4 to the first embossing unit 2, there are provided a third and fourth supply reel 44 and 45 of plies 46 and 47 on the outer sides of the combination of plies 3 and 4 obtained from the first embossing unit 2, and a fourth reel 49 of the unit 41 in which the semi-worked product 48 is collected.

To ease the application of the plies 46 and 47, relay and guiding roller 50 and 51 are used.

With reference again to the apparatus of FIG. 1, the first embossing unit 2 realizes a combination of plies 3 and 4 associated through the relative projections 55 and 56 in a point-to-point relationship.

In particular, the first gluing roller 8 applies the adhesive to the points of the projections of the ply 3 so that they can glue to the corresponding points of the projections of the ply 4, then the second gluing roller 24 applies the adhesive to the points of the projections of the ply 6 so that they can be glued to the outer side of the ply 3 of the combination of plies 3 and 4.

When the combination of plies 3 and 4 enters the second embossing unit 5, the ply 6 is applied to the outside of the ply 3 with a random arrangement of its projections 57 with respect to the projections 55 of the ply 3.

With reference to the apparatus of FIG. 2, the first embossing unit 2 realizes a combination of the plies 3 and 4 associated through the relative projections 55 and 56 in a point-to-point relationship.

In the second embossing unit 5, the fourth embossing roller 34 realizes, on the ply 4, projections 61 which, with respect to the projections 56, are positioned in a relationship that is established by adjusting the length of the path of the plies 3 and 4 between the first and second embossing unit 2 and 5.

The synchronization relationship between the rotation of the third embossing roller 17 and of the fourth embossing roller 36 in this case is established.

In particular, such a relationship must be set so that the projections 57 created on the ply 6 by the third embossing roller 17 are positioned at the side of the projections 55 of the ply 3.

Advantageously, however, the synchronization relationship between the rotation of the third embossing roller 17 and of the fourth embossing roller 36 is not stringent, in the sense that it is sufficient that each projection 57 of the ply 6 is positioned in any point between two adjacent projections 55 of the ply 3.

Thus, when the combination of plies 3 and 4 enters into the second embossing unit 5, the ply 6 is applied to the outside of the ply 3 with an arrangement of its projections 57 staggered with respect to the projections 55 of the ply 3.

In this case, the control of the apparatus remains extremely easy since, as stated, it is possible to set, with some degree of freedom, the synchronization of the rotation of the third embossing roller 17 with respect to that of the fourth embossing roller 36.

Furthermore, in this case, the combination of plies 3, 4 and 6 has joining points between ply 6 and ply 3 not in common with the joining points between ply 3 and ply 4, thus improving the ability to slide of the plies and consequently the properties of softness and tactile effect of the product.

In FIG. 3, the apparatus is otherwise identical to that of FIG. 2, except that the ply 6 has a ply 58 placed on top of it before entry into the second embossing unit 5 in which they are simultaneously embossed by the third embossing roller 17 and associated externally with the ply 3.

The product has four plies and thus greater volume with respect to that deriving from the process of FIG. 2.

In all of the cases illustrated here, the absorbency of the product is ensured by the high percentage of free volume possessed by its structure, thanks to the fact that the plies taken by the embossing rollers 7 and 9 of the first embossing unit 2 are always associated with projections in a point-to-point relationship that define large air pockets 60.

One of the striking aspects of the invention is the extreme versatility of the apparatus, which allows a product to be obtained with a number of additional plies to suit needs by simply foreseeing additional modular embossing units in which a stringent synchronisation relationship of the rotation of the rollers that carry out the association of the plies is not required.

The system for realizing a multi-ply absorbent paper product thus conceived is susceptible to numerous modifications and variants, all of which are covered by the inventive concept; moreover, all of the details can be replaced with technically equivalent elements.

In practice, the materials used, as well as the sizes, can be whatever according to requirements and the state of the art.

### EMBODIMENTS

Embodiment 1 is a multi-ply absorbent paper product characterized in that it comprises at least one first ply of paper and at least one second ply of paper associated through projections of equal pitch and height positioned in a point-to-point relationship, and at least one outer third ply of paper associated with said first or second ply through projections positioned in a random or established relationship with said projections in a point-to-point relationship of said first and second ply.

Embodiment 2 is a product according to the previous embodiment, characterized in that the projections of said third ply are staggered with respect to said projections in a point-to-point relationship of said first and second ply.

Embodiment 3 is a product according to one or more of the previous embodiments, characterized in that it has non-embossed plies outside of said first and/or second ply.

1. Apparatus for producing a multi-ply absorbent paper product, comprising:
a first embossing unit, having a first and a second embossing roller that are coupled and suitable for embossing and associating together at least a first ply of paper and at least one second ply of paper;
said first embossing unit being arranged to provide projections of said first and second ply associated in a point-to-point relationship;
at least one second embossing unit separate from said first embossing unit, having at least one third embossing roller coupled with a fourth roller and suitable for embossing at least one third ply of paper and associating it externally with said at least one first or second ply of paper; wherein said first embossing unit is arranged with respect to the second embossing unit such that a reduction of the synchronization between the first and second embossing units is effected by associating projections of said third ply in a random or predetermined relationship with the projections of said first and second ply, realized in said first embossing unit.

2. Apparatus according to claim 1, wherein said first and second embossing rollers have projections of equal pitch and height and in use rotate with a synchronization relationship such as to make said projections match up.

3. Apparatus according to claim 1, wherein said fourth roller lacks projections and rotates with a random synchronization relationship with respect to said third embossing roller.

4. Apparatus according to claim 2, wherein said fourth roller lacks projections and rotates with a random synchronization relationship with respect to said third embossing roller.

5. Apparatus according to claim 1, wherein said fourth roller is a fourth embossing roller that rotates with respect to said third roller with a defined synchronization relationship so that the projections created in said at least third ply are positioned at the side of the projections created in said first and second ply in said first embossing unit.

6. Apparatus according to claim 1, further comprising an applying unit of at least one non-embossed ply of paper outside of said first and/or second ply coming out from said first embossing unit, and a reeling unit of the semi-worked product thus obtained.

7. Apparatus according to claim 1, wherein said apparatus includes a plurality of separate modular embossing units.

8. Process for producing a multi-ply absorbent paper product, comprising the steps of:
carrying out an embossing of at least one first ply of paper and at least one second ply of paper and their association in a first embossing unit;
creating projections of said first and second embossed ply in said first embossing unit such that they are associated in a point-to-point relationship;
carrying out an external embossing of at least one third ply of paper in at least one second embossing unit separate from the first embossing unit; and,
when said third ply of paper is embossed with said first or second ply, associating in a random or predetermined relationship projections of said third ply and projections of said first and second ply, realized in said first embossing unit, thereby reducing the synchronization between the first and second embossing units.

9. Process according to claim 8, further comprising creating a series of the projections of equal pitch and height in said first and second ply with the first embossing unit.

10. Process according to claim 8, further comprising positioning the projections of said third ply in a staggered relationship in a point-to-point relationship with respect to said projections realized on said first and second ply in said first embossing unit.

11. Process according to claim 9, further comprising positioning the projections of said third ply in a staggered relationship in a point-to-point relationship with respect to said projections realized on said first and second ply in said first embossing unit.

12. Process according to claim 8, further comprising applying at least one ply of non-embossed paper outside of said first and/or second ply of paper coming out from said first embossing unit; reeling the semi-worked product thus obtained; and then, supplying said semi-worked product to said second embossing unit.

13. Process according to claim 9, further comprising applying at least one ply of non-embossed paper outside of said first and/or second ply of paper coming out from said first embossing unit; reeling the semi-worked product thus obtained and then supplying said semi-worked product to said second embossing unit.

14. Process according to claim 10, further comprising applying at least one ply of non-embossed paper outside of said first and/or second ply of paper coming out from said first embossing unit; reeling the semi-worked product thus obtained and then supplying said semi-worked product to said second embossing unit.
